(19) United States
(12) Patent Application Publication
(10) Pub. No.: US 2005/0117030 A1
(43) Pub. Date: Jun. 2, 2005

(54) Digital photographing apparatus and file management method thereof

(75) Inventor: Min-ju Kim, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/001,531

(22) Filed: Dec. 1, 2004

(30) Foreign Application Priority Data
Dec. 2, 2003 (KR) 2003-86755

(51) Int. Cl. H04N 5/76

(52) U.S. Cl. 348/231.1

(57) ABSTRACT

Provided is a digital photographing apparatus, in which the remaining memory size is calculated to provide information on the available number of image photographs, the available motion picture photographing time, and the available sound recording time and the information is displayed on a screen. The files of a digital photographing apparatus are managed by selecting files to be deleted, displaying the size of the files to be deleted under the presently set photographing conditions of a digital photographing apparatus, determining whether to delete the selected files, and deleting the selected files.

### BACKGROUND OF THE INVENTION

This application claims the priority of Korean Patent Application No. 2003-86755, filed on Dec. 2, 2003, in the Korean Intellectual Property Office, the disclosure of which is incorporated herein in its entirety by reference.

1. Field of the Invention

The present invention relates to a digital photographing apparatus, for example, a digital camera, and a method of managing files of the digital photographing apparatus, and more particularly, to a digital photographing apparatus which displays memory information, and a method of managing files of the digital photographing apparatus.

2. Description of the Related Art

In a conventional digital photographing apparatus, for example, a digital camera filed by the present applicant and disclosed in U.S. Patent Publication No. 119,876 entitled “Method of Notification of Inadequate Picture Quality,” only the available time for photographing and the available number of image photographs are displayed and only with respect to the remaining memory size. Thus, the conventional digital photographing apparatus has the following drawbacks.

First, since only the available time for photographing and the available number of image photographs are displayed, the user does not see various other types of helpful information.

Second, since only the available time for photographing and the available number of image photographs are calculated with respect to the remaining memory size, when the user deletes files from the memory, the user is not able to anticipate the available number of remaining image photographs, the remaining minutes to photograph a motion picture, and the remaining minutes to perform sound recording after deleting the files.

### SUMMARY OF THE INVENTION

To solve the above and/or other problems, the present invention provides a digital photographing apparatus having a memory size display function which can be easily recognized by a user and a method of managing files of the digital photographing apparatus.

According to an aspect of the present invention, there is provided a digital photographing apparatus, in which the remaining memory size is calculated to provide information on the available number of image photographs, the available motion picture photographing time, and the available sound recording time and the information is displayed on a screen.

According to another aspect of the present invention, there is provided a digital photographing apparatus, wherein, when files to be deleted are selected, the size of the files selected to be deleted is calculated to provide information on the equivalent number of image photographs, the equivalent motion picture photographing time, and the equivalent sound recording time and the information is displayed on a screen.

According to another aspect of the present invention, there is provided a digital photographing apparatus, wherein, when files to be deleted are selected, the size of the files selected to be deleted is calculated to provide information on either the equivalent number of image photographs, the equivalent motion picture photographing time, or the equivalent sound recording time, according to presently set photographing conditions, and the information is displayed on a screen.

According to another aspect of the present invention, there is provided a method of managing files of a digital photographing apparatus, the method comprising selecting files to be deleted, displaying a size of the files to be deleted under presently set photographing conditions of a digital photographing apparatus, determining whether to delete the selected files, and deleting the selected files.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view illustrating a digital photographing apparatus according to an embodiment of the present invention;

FIG. 2 is a rear view of the digital photographing apparatus of FIG. 1;

FIG. 3 is a block diagram showing an overall configuration of the digital photographing apparatus of FIG. 1;

FIG. 4 is a view illustrating a screen displaying a remaining memory size;

FIG. 5 is a view illustrating an example of a function to select a file to be deleted;

FIG. 6 is a view illustrating an example of a screen displaying a memory size corresponding to the size of the files selected to be deleted in FIG. 5;

FIG. 7 is a flow chart for explaining a method of managing files of a digital photographing apparatus according to an embodiment of the present invention;

FIG. 8 is a view illustrating an example of a screen displaying the size of files to be deleted; and

FIG. 9 is a flow chart for explaining a method of managing files of a digital photographing apparatus according to another embodiment of the present invention.

### DETAILED DESCRIPTION OF THE INVENTION

Referring to FIG. 1, a digital photographing apparatus 1, for example, a digital camera, according to an embodiment of the present invention includes a microphone MIC, a self-timer lamp 11, a flash 12, a shutter button 13, a mode dial 14, a function-section button 15, a photographing-information display portion 16, a viewfinder 17a, a function-block button 18, a flash-light amount sensor 19, a lens portion 20, and an external interface portion 21.

The self-timer 11 operates for a set time from a point when the shutter button 13 is pressed to a point when a shutter (not shown) operates in a self-timer mode. The mode dial 14 is used for a user to select and set various modes, for example, a still image photographing mode, a night view photographing mode, a motion picture photographing mode, a reproduction mode, a computer connection mode, and a system setting mode. The function-selection button 15 is used for the user to select one of operation modes of the digital photographing apparatus 1, for example, the still picture photographing mode, the night view photographing mode, the motion picture photographing mode, and the production mode. The photographing-information display portion 16 displays information of each function related to photographing. The function-block button 18 is used for the user to select each function displayed on the photographing-information display portion 16.

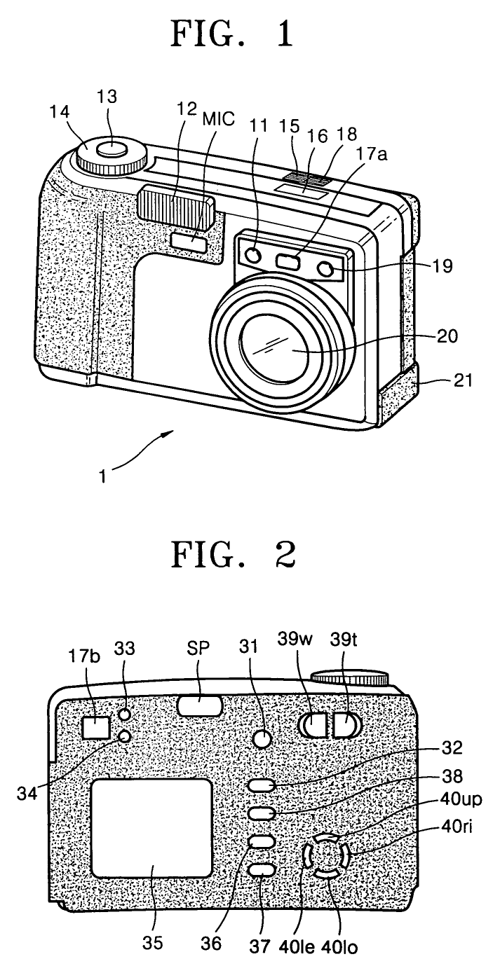

Referring to FIG. 2, a speaker SP, a power button 31, a monitor button 32, an automatic-focus lamp 33, a viewfinder 17b, a flash ready lamp 34, a display panel 35, a confirm/delete button 36, an enter/play button 37, a menu button 38, a wide-angle zoom button 39w, a telephoto zoom button 39t, an up-move button 40up, a right-move button 40ri, a down-move button 40lo, and a left-move button 40le are disposed on a read side of the digital photographing apparatus 1 of FIG. 1.

The monitor button 32 is used for the user to control the operation of the display panel 35. For example, when the user first presses the monitor button 32, the display panel 35 displays an image of an object being photographed and photographing information. On the second press of the monitor button 32, the display panel 35 displays only the image of an object being photographed. On the third press of the monitor button 32, power applied to the display panel 35 is cut off. The automatic-focus lamp 33 operates only when an automatic focusing operation is complete. The flash ready lamp 34 operates when the flash 12 of FIG. 1 is in an operation ready state. The confirm/delete button 36 is used as a confirm button or a delete button when the user sets each mode. The enter/play button 37 is used to input data or stop or reproduce in a reproduction mode. The menu button 38 is used to display a menu of a mode selected by the mode dial 14. The up-move button 40up, the right-move button 40ri, the down-move button 40lo, and the left-move button 40le are used for the user to set each mode.

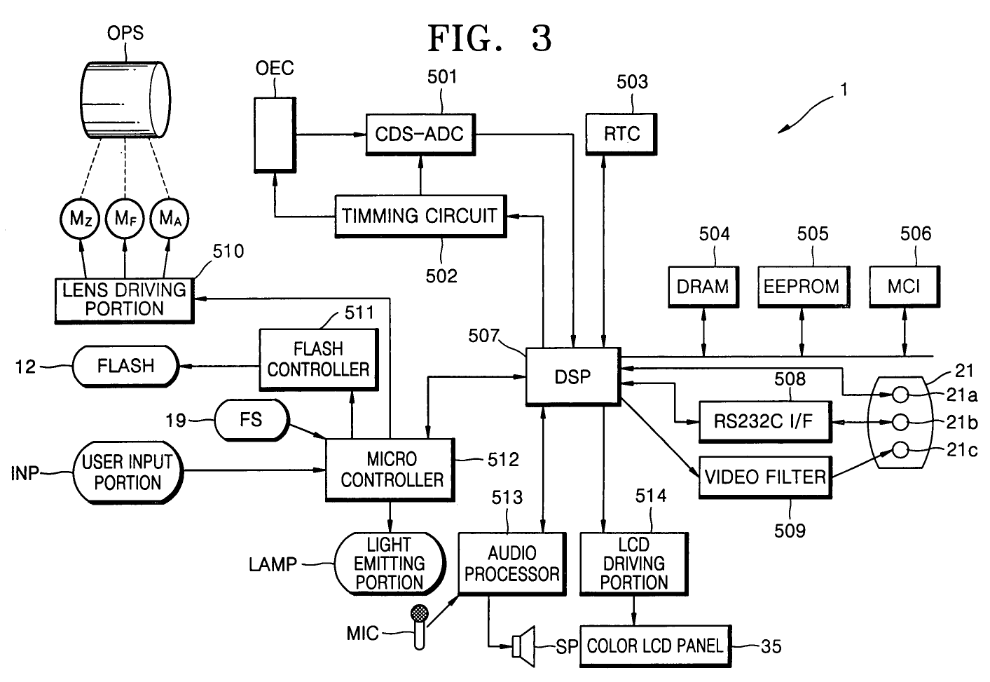

Referring to FIG. 3, in the overall configuration of the digital photographing apparatus 1 of FIG. 1, an optical system OPS including a lens portion and a filter portion optically processes light reflected from an object to be photographed. An optoelectronic converter (OEC) of a charge coupled device (CCD) or complementary metal-oxide-semiconductor (CMOS) converts the light output from the OPS to an electric analog signal. A digital signal processor (DSP) 507 controls operation of the OEC and an analog-to-digital conversion portion by controlling a timing circuit 502. A correlation double sampler and analog-to-digital converter (CDS-ADC) 501 as the analog-to-digital conversion portion processes an analog signal output from the OEC by removing the low frequency noise thereof and adjusting the amplitude thereof so as to be converted to a digital signal. The DSP 507 processes a digital signal output from the CDS-ADC 501 and generates a digital image signal divided into a luminance signal and a chrominance signal.

A dynamic random access memory (DRAM) 504 temporarily stores the digital image signal output from the DSP 507. An electrically erasable programmable read only memory (EEPROM) 505 stores algorithm and setting data needed in the operation of the DSP 507. A user's memory card is inserted in or removed from a memory card interface (MCI) 506. The digital image signal output from the DSP 507 is input to an LCD driving portion 514 and an image is displayed on the color LCD panel 35.

The digital image signal output from the DSP 507 can be transmitted in serial communication through a universal serial bus (USB) connection portion 21a, or an RS232C interface 508 and a connection portion 21b thereof, and through a video filter 509 and a video output portion 21c as a video signal.

An audio processor 513 outputs a voice signal output from a microphone MIC to the DSP 507 or a speaker SP and outputs the audio signal from the DSP 507 to the speaker SP.

A user input portion INP includes the shutter button 13 of FIG. 1, the mode dial 14 of FIG. 1, the function-selection button 15 of FIG. 1, the function-block button 18 of FIG. 1, the monitor button 32 of FIG. 2, the confirm/delete button 36 of FIG. 2, the enter/play button 37 of FIG. 2, the menu button 38 of FIG. 2, the wide-angle zoom button 39w of FIG. 2, the telephoto zoom button 39t of FIG. 2, the up-move button 40up FIG. 2, the right-move button 40ri FIG. 2, the down-move button 40lo of FIG. 2, and the left-move button 40le of FIG. 2.

A microcontroller 512 controls a lens driving portion 510 and accordingly a zoom motor M_{Z}, a focus motor M_{F}, and an aperture motor M_{A} drive a zoom lens, a focus lens, and an aperture in the OPS, respectively. A light emitting portion LAMP driven by the microcontroller 512 includes the self-timer lamp 11 of FIG. 1, the automatic-focus lamp 33 of FIG. 2, and the flash ready lamp 34 of FIG. 2. The microcontroller 512 controls the operation of a flash controller 511 according to a signal output from the flash-light amount sensor 19 of FIG. 1, to drive the flash 12.

A digital photographing apparatus to which the present invention can be applied does not need to include all the constituent elements shown in FIGS. 1 through 3. Those skilled in the art can understand that some of the constituent elements are deleted, other constituent elements are added, or some of the constituent elements are modified according to the specification of the digital photographing apparatus.

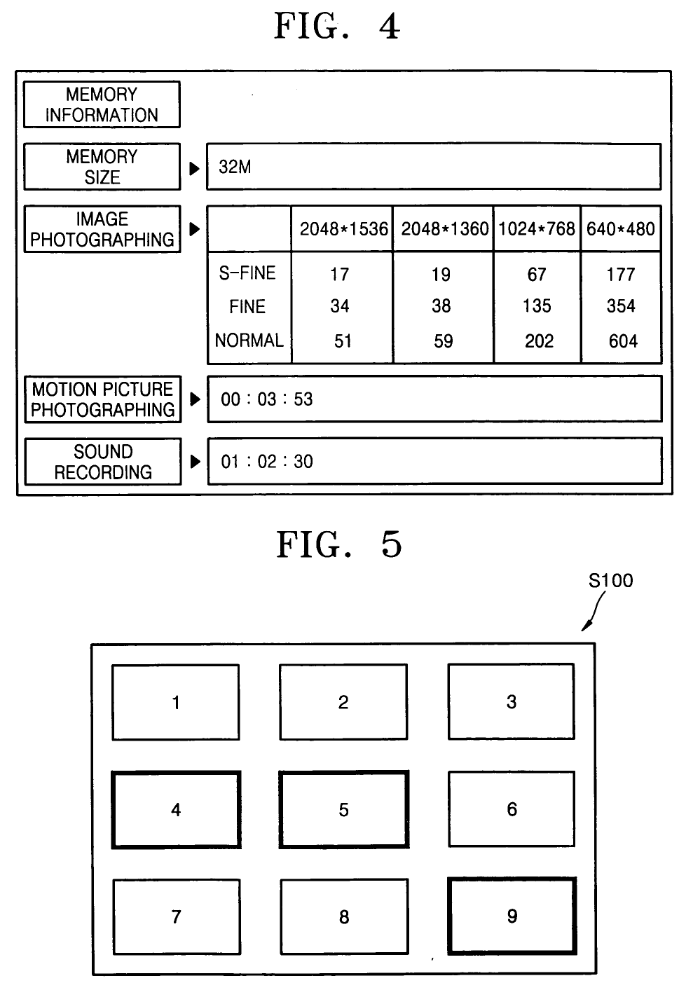

FIG. 4 is a view illustrating a screen displaying a remaining memory size. Referring to FIG. 4, the remaining memory size is 32 Mbytes and accordingly the available motion picture photographing time of 3 minutes and 53 seconds and the available sound recording time of 1 hour, 2 minutes, and 30 seconds are displayed.

The digital photographing apparatus according to the present invention can be embodied such that all numbers of images to be photographed according to the size and quality of an image can be displayed. On a screen shown in FIG. 4, “2048*1536”, “2048*1360”, “1024*768”, and “640*480” are the sizes of an image while “S-FINE”, “FINE”, and “NORMAL” denote the quality of an image. For example, the remaining memory size of 32 Mbytes denotes that 17, 19, 67, and 177 images can be photographed with respect to the image sizes “2048*1536”, “2048*1360”, “1024*768”, and “640*480”, respectively, at the image quality “S-FINE”. Also, the remaining memory size of 32 Mbytes denotes that 34, 38, 135, and 354 images can be photographed with respect to the image sizes “2048*1536”, “2048*1360”, “1024*768”, and “640*480”, respectively, at the image quality “FINE”. Further, the remaining memory size of 32 Mbytes denotes that 51, 59, 202, and 604 images can be photographed with respect to the image sizes “2048*1536”, “2048*1360”, “1024*768”, and “640*480”, respectively, at the image quality “NORMAL”.

The digital photographing apparatus according to the present invention can be embodied such that the number of images corresponding to the presently set size and quality of an image can be displayed as the available number of image photographs.

The digital photographing apparatus according to the present invention includes a memory button (not shown). When a user presses the memory button, the remaining memory size is calculated and information is provided on the available number of image photographs, the available motion picture photographing time, and the available sound recording time. Information regarding the remaining memory is displayed on a screen as shown in FIG. 4. The memory button can be provided as one constituent element of the user input portion INP.

When the user presses the memory button, the digital photographing apparatus can be embodied to perform a memory size display function regardless of the current use state.

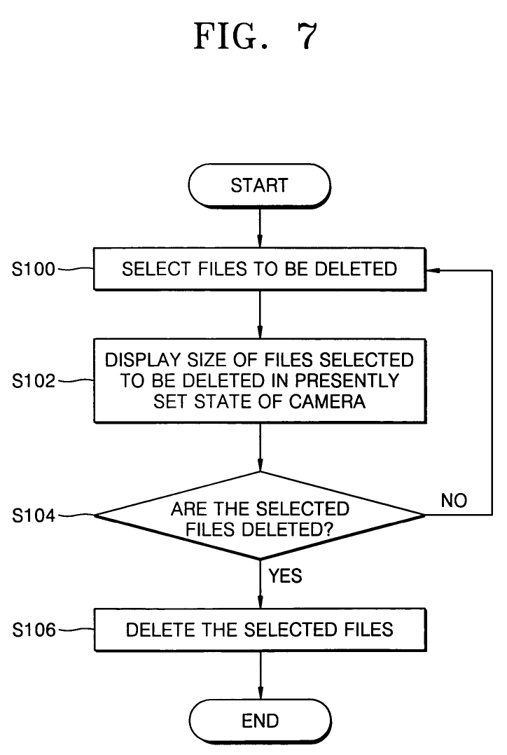

FIG. 5 is a view illustrating an example of a function to select a file to be deleted. The digital photographing apparatus according to the present invention provides the function of displaying images on a thumbnail view screen, as shown in FIG. 5, and separately or concurrently selecting one or more image files in a thumbnail view and simultaneously deleting one or more selected image files by the user's operation of the directional buttons 40up, 40lo, 40le, and 40ri of FIG. 2 and the selection button 36 of FIG. 2. In FIG. 5, the fourth, fifth, and ninth image files are selected on the thumbnail view screen. The operation of FIG. 5 can be performed in the step S100 of FIG. 7.

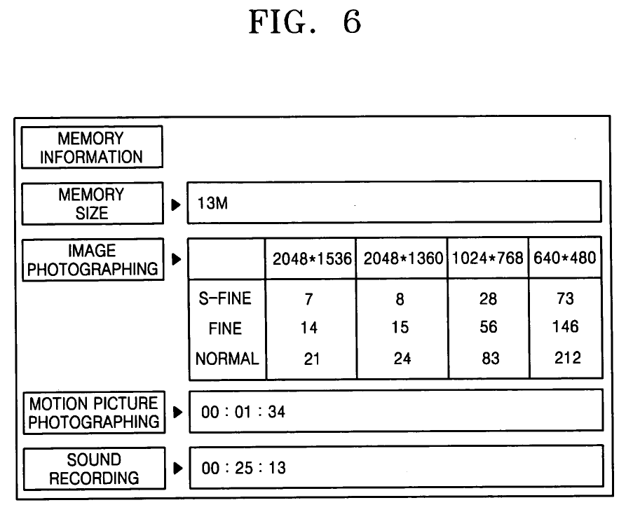

FIG. 6 is a view illustrating an example of a screen displaying the memory size corresponding to the size of the files selected to be deleted in FIG. 5. Referring to FIG. 6, the memory size of the files selected to be deleted is 13 Mbytes which is calculated as 1 minute and 34 seconds of motion picture photographing available time or 25 minutes and 13 seconds of sound recording available time.

The screen shown in FIG. 6 indicates that the “13 Mbytes” that is the size of the files selected to be deleted is, for example, equivalent to 7, 8, 28, and 73 images to be photographed with respect to the image sizes “2048*1536”, “2048*1360”, “1024*768”, and “640*480”, respectively, at the image quality “S-FINE”. The “13 Mbytes” that is the size of the files selected to be deleted is, for example, equivalent to 14, 15, 56, and 146 images to be photographed with respect to the image sizes “2048*1536”, “2048*1360”, “1024*768”, and “640*480”, respectively, at the image quality “FINE”. The “13 Mbytes” that is the size of the files selected to be deleted is, for example, equivalent to 21, 24, 83, and 212 images to be photographed with respect to the image sizes “2048*1536”, “2048*1360”, “1024*768”, and “640*480”, respectively, at the image quality “NORMAL”.

FIG. 7 is a flow chart for explaining a method of managing files of a digital photographing apparatus according to an embodiment of the present invention. In the method of managing files according to the present embodiment, files to be deleted are selected using the directional buttons and the selection button (S100). After the step S100, the memory size of the selected files is displayed in the presently set state of the digital photographing apparatus (S102). Here, the available numbers of image photographs are displayed according to the size and quality of images to be photographed. In the step S102, when the previous photographing mode is a motion picture photographing mode, the digital photographing apparatus can be embodied to display only the motion picture photographing available time. Also, in the step S102, when the previous photographing mode is a sound recording mode, the digital photographing apparatus can be embodied to display only the sound recording available time.

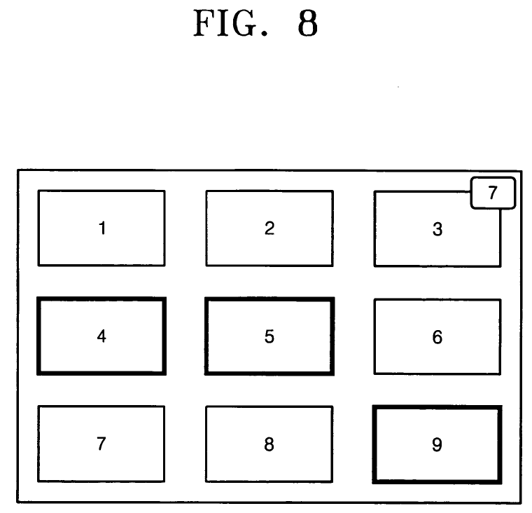

FIG. 8 is a view illustrating an example of a screen displaying the size of the files to be deleted. The screen of FIG. 8 shows the result of performing the.step S102 of FIG. 7 after a plurality of files are selected to be deleted in the step S100 of FIG. 7. When the present photographing condition set just before the step S100 is a picture photographing mode, the size of the files selected to be deleted is calculated to provide the equivalent number of image photographs and is displayed on a screen. On the thumbnail view screen of FIG. 8, the number “7” displayed on the upper right corner of the screen denotes that the file size of the three images selected to be deleted is equivalent to 7 images that can be photographed in the presently set image size and quality state.

When the present photographing condition set just before the step S100 is a motion picture photographing mode or a sound recording mode, the number “7” in FIG. 8 denotes either the equivalent time for motion picture photographing or the equivalent time for sound recording, instead of the number of images to be photographed.

In the embodiment shown in FIG. 8, when two or more files are selected to be deleted, the number is updated to reflect the total size of the files selected to be deleted whenever an additional file is selected to be deleted.

After the step S102, it is determined whether to delete the selected files (S104). In this case, the determination of whether to delete the selected files is performed by the user pressing the delete button (S104). If it is determined that the selected files are to be deleted, deletion is performed (S106). However, if it is determined that the selected files are not to be deleted, the program goes to the step S100 and another file can be selected.

Although it is not shown in the drawings, when the selected files are determined not to be deleted, the method of managing files shown in FIG. 7 can be terminated.

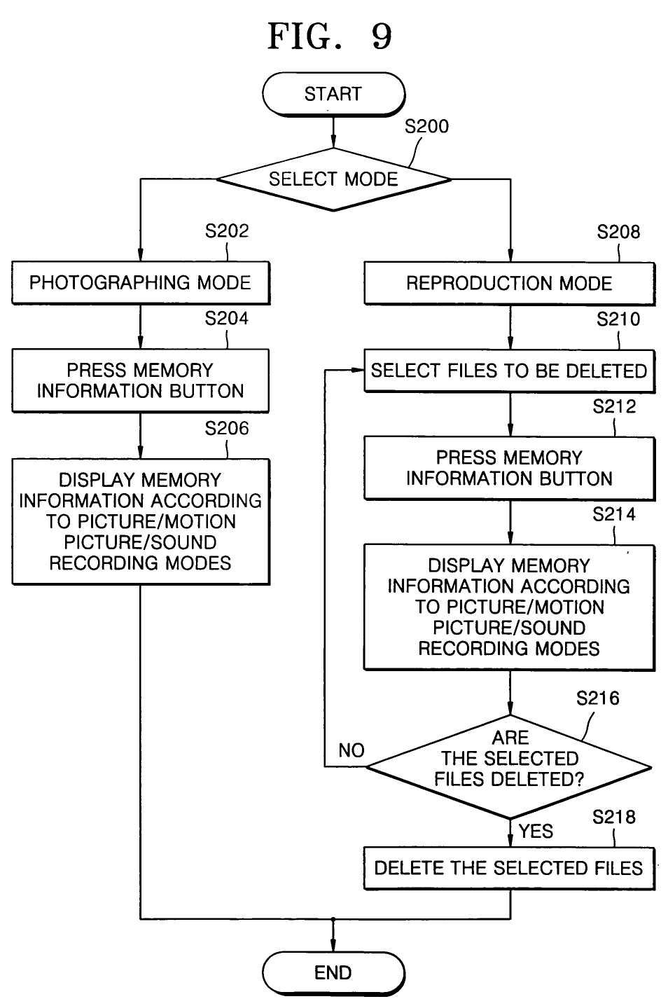

FIG. 9 is a flow chart for explaining a method of managing files of a digital photographing apparatus according to another embodiment of the present invention, by which the memory size can be displayed differently according to modes. Referring to FIG. 9, the mode is selected (S200). In the digital photographing apparatus, the selection of a mode can be performed using the mode dial 14 of FIG. 1.

A photographing mode is selected by user's operating the mode dial 14 (S202). In this state, when the user presses the memory button (S204), the digital photographing apparatus displays information on the memory size according to picture/motion picture/sound recording modes, on the screen (S206). When the memory button is not pressed in the step S204, the digital photographing apparatus is in a ready state to wait for an instruction by the user.

A reproduction mode is selected by operating the mode dial 14 in the step S200 (S208). In this state, when the files to be deleted are selected (S210), the digital photographing apparatus displays information on the memory size according to picture/motion picture/sound recording modes, on the screen (S214). The step S214 can be performed only when the memory button is pressed by the user in the step S212. The digital photographing apparatus determines whether to delete the selected files (Step 216). In the step S216, the deletion of the selected files can be determined, for example, by user's pressing the delete button with reference to the memory size information displayed on the screen. If the selected files are determined to be deleted, the selected files are deleted (S218). However, if the selected files are determined not to be deleted, the program goes to the step S210 to select another file. Although it is not shown in the drawings, the method of managing files shown in FIG. 9 can be terminated if the selected files are determined not to be deleted in the step S216.

When the method of managing files shown in FIG. 9 is terminated, the digital photographing apparatus is in a ready mode and waits for the next instruction such as a mode selection, a reproduction instruction, or a photographing instruction.

The digital photographing apparatuses according to the above embodiments are not applied to a general digital camera only. It is understood by those skilled in the art that the digital photographing apparatuses according to the above embodiments can be applied to other multimedia devices having a digital photographing function. For example, a mobile phone or a camcorder having the digital photographing function is in the range of the digital photographing apparatus according to the present invention. Also, in the above embodiments, although a memory card is used as a file storing unit of a digital photographing apparatus, the present invention is not limited thereto and a flash memory can be used therefor in addition to the memory card.

As described above, according to the present invention, the remaining memory size is calculated to provide information on the available number of image photographs, the available motion picture photographing time, and the available sound recording time and the information is displayed on a screen, so that a user can easily anticipate the amount of space available for the next photographing work. Also, when the user is about to delete files, the present invention provides information such as how many images the user can photograph, how many minutes the user can photograph a motion picture, and how many minutes the user can record sound, which provides convenience to the user in determining the how many files should be deleted or in selecting the files to be deleted.

While this invention has been particularly shown and described with reference to preferred embodiments thereof, it will be understood by those skilled in the art that various changes in form and details may be made therein without departing from the spirit and scope of the invention as defined by the appended claims.

1. A digital photographing apparatus comprising:
means for calculating information regarding the available number of image photographs, the available motion picture photographing time, and the available sound recording time for the remaining memory size; and
a display for displaying the calculated information.

2. The apparatus as claimed in claim 1 further comprising a memory input mechanism, wherein, when the memory input mechanism is activated, the available number of image photographs, the available motion picture photographing time, and the available sound recording time is calculated for the remaining memory size and the information is displayed on a screen.

3. The apparatus as claimed in claim 1, wherein the available number of image photographs varies according to the size and quality of images to be photographed.

4. A digital photographing apparatus comprising:
means for selecting files to be deleted;
means for calculating, for the files selected to be deleted, the equivalent number of image photographs, the equivalent motion picture photographing time, and the equivalent sound recording time; and
a display for displaying the calculated information.

5. The apparatus as claimed in claim 4, wherein, when two or more files are selected to be deleted, whenever an additional file is selected to be deleted, the total size of the files selected to be deleted is calculated to provide information on the equivalent number image photographs, the equivalent motion picture photographing time, and the equivalent sound recording time and the information is displayed on a screen.

6. The apparatus as claimed in claim 4 further comprising a memory input mechanism, wherein, when the memory input mechanism is activated, the size of the files selected to be deleted is calculated to provide information regarding the equivalent number of image photographs, the equivalent motion picture photographing time, and the equivalent sound recording time and the information is displayed on a screen.

7. The apparatus as claimed in claim 4 further comprising a memory input mechanism, wherein, when the memory input mechanism is activated, the remaining memory size after the files selected to be deleted are deleted is calculated to provide information regarding the available number of image photographs, the available motion picture photographing time, and the available sound recording time and the information is displayed on a screen.

8. The apparatus as claimed in claim 4, wherein the equivalent number of image photographs varies according to size and quality of images to be photographed.

9. The apparatus as claimed in claim 4, wherein the equivalent number of image photographs is the equivalent number of image photographs corresponding to the presently set image size and quality.

10. A digital photographing apparatus comprising
means for selecting files to be deleted;
means for calculating for the files selected to be deleted the equivalent number of image photographs, the equivalent motion picture photographing time, or the equivalent sound recording time according to the presently set photographing conditions; and
a display for displaying the calculated information.

11. The apparatus as claimed in claim 10, wherein, when two or more files are selected to be deleted, whenever an additional file is selected to be deleted, the total size of the files selected to be deleted is calculated to provide information regarding the equivalent number of image photographs, the equivalent motion picture photographing time, or the equivalent sound recording time according to presently set photographing conditions, and the information is displayed on a screen.

12. A method of managing files of a digital photographing apparatus, the method comprising:
selecting the files to be deleted;
displaying the size of the files to be deleted;
determining whether to delete the selected files; and
deleting the selected files.

13. The method as claimed in claim 12, wherein, in the displaying of the size of the files to be deleted, according to an instruction by a user, the size of the files to be deleted is displayed under the present set of photographing conditions of the digital photographing apparatus.

14. The method as claimed in claim 12, wherein, when two or more files are selected to be deleted, in the displaying of a size of the files to be deleted, whenever an additional file is selected to be deleted, the total size of the files selected to be deleted is calculated to provide information regarding the equivalent number of image photographs, the equivalent motion picture photographing time, or the equivalent sound recording time according to the presently set photographing conditions and the information is displayed on a screen.

15. A method for a digital photographing apparatus, in which information regarding the remaining memory size is provided, the method comprising:
calculating for the remaining memory size the available number of image photographs, the available motion picture photographing time, and the available sound recording time; and
displaying the calculated information.

16. The method as claimed in claim 15 further comprising the activating of a memory input mechanism to calculate for the remaining memory size the available number of image photographs, the available motion picture photographing time, and the available sound recording time.

17. The method as claimed in claim 15, wherein the available number of image photographs varies according to the size and quality of images to be photographed.

18. A method for a digital photographing apparatus, in which information regarding the files selected to be deleted is provided, the method comprising:
selecting files to be deleted;
calculating the size of the files selected to be deleted to provide information on the equivalent number of image photographs, the equivalent motion picture photographing time, and the equivalent sound recording time; and
displaying the calculated information.

19. The method as claimed in claim 18, wherein, when two or more files are selected to be deleted, whenever an additional file is selected to be deleted, the method further comprises:
calculating the total size of the files selected to be deleted to provide information regarding the equivalent number image photographs, the equivalent motion picture photographing time, and the equivalent sound recording time; and
displaying the information on a screen.

20. The method as claimed in claim 18 further comprising activating a memory input mechanism to calculate the equivalent number of image photographs, the equivalent motion picture photographing time, and the equivalent sound recording time for the size of the files selected to be deleted and displaying the information on a screen.

21. The method as claimed in claim 18 further comprising activating a memory input mechanism to calculate the available number of image photographs, the available motion picture photographing time, and the available sound recording time for the remaining memory size after the files selected to be deleted are deleted and displaying the information on a screen.

22. The method as claimed in claim 18, wherein the equivalent number of image photographs varies according to size and quality of images to be photographed.

23. The method as claimed in claim 18, wherein the equivalent number of image photographs is the equivalent number of image photographs corresponding to size and quality of an image that is presently set.

24. A method for a digital photographing apparatus, in which information regarding the files selected to be deleted is provided, the method comprising:
selecting the files to be deleted;
calculating for the size of the files selected to be deleted information on either the equivalent number of image photographs, the equivalent motion picture photographing time, or the equivalent sound recording time according to the presently set photographing conditions; and
displaying the information.

25. The method as claimed in claim 24, wherein, when two or more files are selected to be deleted, whenever an additional file is selected to be deleted, the method further comprises:
calculating the total size of the files selected to be deleted to provide information on the equivalent number of image photographs, the equivalent motion picture photographing time, or the equivalent sound recording time, according to presently set photographing conditions; and
displaying the information on a screen.
